(19) United States
(12) Patent Application Publication
(10) Pub. No.: US 2007/0116987 A1
(43) Pub. Date: May 24, 2007

(54) Nanosized metal and metal oxide particles as a biocides in roofing coatings

(76) Inventors: Amir G. Khan, Wayne, NJ (US); Charles J. Horner JR., Belle Mead, NJ (US)

Correspondence Address: SILLS CUMMIS EPSTEIN & GROSS P.C., ONE RIVERFRONT PLAZA, IP DEPARTMENT, NEWARK, NJ, 07102, US

(21) Appl. No.: 11/454,335

(22) Filed: Jun. 16, 2006

Related U.S. Application Data
(60) Provisional application No. 60/691,300, filed on Jun. 16, 2005.

(51) Int. Cl. B32B 9/00

(52) U.S. Cl. 428/701

(57) ABSTRACT

Nanosized metals and metal oxides for incorporation in biocidal coatings for application upon building materials and products and which are effective in protecting the building product against bacteria (particularly cyanobacteria), fungi, molds, algae and other bio-organisms known to deface and/or adversely affect such building materials. A method of coating roofing products with the biocidal coatings are also disclosed.

### RELATED APPLICATIONS

This application claims the benefit of U.S. Provisional Application No. 60/691,300, filed Jun. 16, 2005.

### FIELD OF THE INVENTION

The present invention relates to the use of nanosized metal and metal oxide particles in building materials. More specifically, the present invention relates to the use of nanosized metal and metal oxide particles as biocides in coatings that are used on roofing products for protection against bacteria (particularly cyanobacteria), fungi, molds, algae and other bio-organisms known to deface and/or adversely affect such materials.

### BACKGROUND

Asphalt roofing shingles and other roofing products are frequently subject to the growth of cyanobacteria, often referred to as fungus or blue-green algae. Such bacteria growth is often discoloring, unsightly and hastens product deterioration. Early on it was found that the presence of some metals and metal oxides, such as copper, zinc, nickel, lead, iron and zinc oxide reduced or eliminated cyanobacterial growth on roofing shingles. In some instances, metals were placed as strips on the roof or incorporated into ceramic granules already a component of the roof shingles.

Because prior art metal granules were relatively large in size, they often changed the appearance of the roofing shingles they were added to. For instance, dark colored copper granules mixed in with light colored ceramic granules changed the shingle's overall color in an undesirable way. In addition, such large copper or zinc granules did not make efficient use of the metal or metal oxide's biocidal activity.

Metals and metal oxides have recently been commercially reduced to nanosize (10-100 nanometer diameter) particles. When nanosized particles are used, because of their extremely small size, the total surface area is maximized, resulting in the highest possible effect per unit size. As a result, nanosized particles of copper oxide and/or zinc oxide provide more efficiency than larger particles used in concentrations many times greater. Such nanoparticles, when used as additives in coatings, are often transparent, allowing the esthetics of the coated substrates to remain unchanged. Bio-organisms treated by these particles do not acquire resistance to the metals or metal oxides. Therefore, in coatings, the biocidal metals and metal oxides have advantages over the conventional biocides (such as organic biocides) which often cause the selection of biocide-resistant microorganism.

Although nanosized metal and metal oxides have truly demonstrated many broad applications, they have not yet been utilized as biocides in roofing materials. Roofing materials are subjected to attack by numerous biological organisms, including various molds, fungus and cyanobacteria.

Prior art biocides in coatings for roofing materials include organic biocides such as 2-octylthiazol-3-one (Skane M8), Rozone 2000, Rozone 2002, Rocima 63, Rocima 65 (from Rohm & Haas Co., Philadelphia, Pa.) or zinc omadine (Arch Chemicals, Inc., Norwalk, Conn.) and others. Such prior art coating biocides have several disadvantages. First, prior art biocides are not active against all organisms that might attack roofing or building products, at the dosages used. Second, some have toxicities that may be harmful to workers during manufacture. Finally, some of the prior art biocides require relatively high amounts of biocide and their use can be very expensive.

### SUMMARY OF THE INVENTION

The present invention relates to the use of nanosized metal and/or nanosized metal oxide particles, such as, for example, nanocopper oxide or nanozinc oxide, as components in a coating for roofing products, including, but not limited to, asphalt shingles; concrete tiles; thermoplastic and thermoset shakes, slates and tiles; wood shakes; metal shakes and panels; and fiber cement shakes, slates and tiles; single ply membranes such as polyvinyl chloride (PVC), thermoplastic olefin (TPO), EPDM and neoprene rubber, hypalon and similar membranes, polymer modified bitumen); build-up roofing (BUR) systems; and roof accessories.

The invention also includes treatment of wood shakes used in roofing or siding with nano metal and nano metal oxide containing coatings or saturants. Such materials could be applied with or without pressure treatment.

The invention also relates to the use of nanosized metal and/or nanosized metal oxide particles added to clear and opaque coating applied to steep or low slope roofing materials. Such coatings could be aqueous or non-aqueous and could be applied during or after manufacture or after the roof is applied. Along with resistance to molds, fungus, algae and bacteria, such coatings can impart greater durability and better esthetics.

Furthermore, the invention is directed to nano metal and nano metal oxide materials in coatings which we show to impart anti-biocidal and anti-microbial activity to roofing and similar building materials for protection against bacteria (particularly cyanobacteria), fungi, molds, algae and other bio-organisms known to deface and/or adversely affect such building materials.

The above and other features of the invention, including various novel details of construction and combinations of parts, will now be more particularly described with reference to the accompanying drawings and pointed out in the claims. It will be understood that the particular device embodying the invention is shown by way of illustration only and not as a limitation of the invention. The principles and features of this invention may be employed in various and numerous embodiments without departing from the scope of the invention.

### DETAILED DESCRIPTION

In accordance with the present invention, nanosized particles, particularly nanocopper-oxide, nanozinc-oxide and combinations of the two are added to the formulation of a coating used on asphaltic roofing shingles, to form a fungus, algae or cyanobacteria resistant product. The coating is also effective in killing and/or preventing the growth of mold fungus, algae or bacteria. The coating may be aqueous or solvent based, but aqueous latex is preferred. Coating can be unfilled forming a clear coat or filled (such as with one or more fillers or pigments) and contain common additives known to those skilled in the art.

The substrates in accordance with the present invention may be, but are not limited to, any roofing or similar use building product commonly used in the industry.

The nanosized metal and nanosized metal oxide containing coating according to the present invention does not require the use of substantial quantities in order to function effectively. As such, the coating of the present invention has the significant advantage of low cost while not adversely affecting any of the product's other properties. Furthermore, the nanoparticle coating used in its normal small quantities, does not discolor the coating, allowing significantly enhanced esthetics.

Advantageously, the nanoparticle coating of the present invention is considered fairly non-toxic.

While nanocopper-oxide and nanozinc-oxide have been described with regard to the biocidal formulation of the present invention, the invention is not limited only to those metal oxides and other nanosized metal and nanosized metal oxides and/or ions thereof, such as nanosilver, nanolead, and nanoiron, for example, are also contemplated by the present invention.

In one embodiment, the effective amount of nanosized metal or metal oxide level in the biocidal coating is in the range of approximately 0.05%-10.0% of the coating by dry weight.

The nanosized metal and/or nano metal oxide particle-containing coating is preferably applied during factory manufacture of the roofing product but may also be sprayed, dipped, rolled or brushed on in the field (e.g., on the roof).

The coating of the present invention may also contain some or all of the following: filler(s), surfactant(s), UV stabilizer(s), thermal stabilizer(s), pigment(s), other co-biocides, fibrous reinforcements, strength additives, compatibilizers, water repellants, and/or fire retardants.

The nanosized metal and/or nanosized metal oxide particles in accordance with the present invention may be prepared by any methods commonly known to those skilled in the art, including but not limited to, the use metal powders, crystalline metal nanoparticles, metal complexes or nanosized metal and nanosized metal oxide fixed on zeolite, ceramic, metal or other base particles. Similarly, nanosized metal and nanosized metal oxide oxides may be prepared from metals or metal oxides by known techniques such as, but not limited to plasma generation flame pyrolysis, milling, and sol-gel generation.

### EXPERIMENTAL

According to one example of the invention, laboratory samples of acrylic latex coatings were prepared and applied to asphalt roofing shingles. Coatings contained either nanozinc oxide, nanocopper oxide, a combination of nanozinc- and nanocopper-oxide, or traditional biocides such as Rocima 63, Rocima 65, Skane M8, Rozone 2000 (all manufactured by Rohm & Haas) or Nuocide 2002 (manufactured by ISP Corp., Wayne, N.J.). Control shingles were uncoated.

Table 1 below illustrates the Algae Resistance (AR) rating (rated 1-10, where 1=no algae growth and 10=most algae growth) of the coated shingles according to ASTM D5589. Samples 7 and 8 were coated with coatings containing nanocopper-oxide and nanozinc-oxide, respectively. Samples 7 and 8 were among the lowest (best) ratings when compared to traditional biocides and control (non-coated shingles). Samples were aged for at least three months.

TABLE 1
AR SHINGLES WITH VARIOUS COATINGS AND BIOCIDES

| RATINGS | | | | |
|---|---|---|---|---|
| | After | After | After | |
| SAMPLE | 1 month | 2 months | 3 months | INGREDIENTS |
| C | 2 | 3 | 5 | CONTROL |
| C | 3 | 4 | 4 | CONTROL |
| 1 | 0 | 1 | 2 | Latex + Skane M8 + |
| | | | | Nuo2002 + DC777 |
| 2 | 0 | 1 | 3 | Latex + Skane M8 + |
| | | | | Nuo2002 + DC777 |
| 3 | 0 | 1 | 2 | Latex + Skane M8 + |
| | | | | Nuo2002 + Wet Care |
| 4 | 1 | 1 | 3 | Latex + Rocima 65 |
| 5 | 3 | 3 | 3 | Latex + Rocima 65 |
| 6 | 2 | 3 | 3 | Latex + Rocima 65 |
| C | 0 | 4 | 6 | CONTROL |
| 7 | 0 | 1 | 2 | Latex + BYK LPX 20832 |
| 8 | 0 | 1 | 2 | Latex + BYK LPX 20704 |
| 9 | 0 | 1 | 3 | Latex + Rocima 63 |

Common acrylic latex carriers used for the coating study included: Acronal 310 (optive), NX 4787x, AC 2438, ML200, AC 264, AC 630, AC 2438, E-3494, JTC 2228A, LT 2949, AC 98B. R&H and BASF are the common latex manufacturers. These acrylics are typical acrylic/styrene copolymers with varying glass transition temperatures (T_{g}).

Optionally, a water repellant may be added to the shingle which causes water to bead and shed from the roofing substrate. “DC 777” from Ciba may be used at 1% wt.

Nanocopper oxide and nanozinc oxide were obtained from BYK-Chemie GmbH, at 44% and 50% concentration respectively, in pre-dispersed solution (water).

AR 7

| | Ideal | Wet |
|---|---|---|
| Compound | Formula | Weight(g) |
| H₂O | 60.50% | 60.5 |
| E-3494 | 36.00% | 36 |
| BYK-LP × 20832 = ZnO | 3.50% | 3.5 |
| Total | 100.00% | 100 |

AR 8

| | | Wet |
|---|---|---|
| Compound | Formula | Weight(g) |
| H2O | 60.50% | 60.5 |
| E-3494 | 36.00% | 36 |
| BYK-LP × 20704 = CuO | 3.50% | 3.5 |
| Total | 100.00% | 100 |

Procedure for Preparing Nanosized Metal Coating
1. Under a low shear mixture the nanosized copper is slowly added to the latex.
2. Mixing continues until they become homogenous;
3. The mixture is then added to water under low shear;
4. The mixture is agitated for 20 mins to make sure the nano particles stay suspended in solution. This allows the nanosized metal to attach to the latex functional groups.
5. The above process is repeated for nanosized zinc.

After mixture is blended it is subjected to 5 minutes in the microwave. No difference was seen as a result of microwaving.

Conditions for Testing

The total inoculation time for the test was 6+ weeks, during which an alga usually forms within this period.

Settings:
T=30° C.
Humidity=50%
Light Cycle=10 Hr on/14 Hr off
Media=Allens

Types of Algae grown:
Gloeocapsa sp (Blue Green Algae)
CaloThrix sp (Blue Green Algae)
Chlorella sp (Green Algae)
   ASTM 5589 was used for the testing protocol.

While there has been shown and described what is considered to be one preferred embodiment of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A coating for roofing products, comprising a biocidal formulation containing an effective amount of nanosized metals or metal oxides.

2. The coating of claim 1, wherein said metal or metal oxide is zinc oxide.

3. The coating of claim 1, wherein said metal or metal oxide is copper oxide.

4. The coating of claim 1, wherein said coating is aqueous based.

5. The coating of claim 4, wherein said aqueous based coating is latex.

6. The coating of claim 5, wherein said latex is acrylic latex.

7. The coating of claim 1, wherein said coating is clear.

8. The coating of claim 1, wherein said coating is opaque.

9. The coating of claim 1, wherein said coating further comprises some or all of the following: filler(s), surfactant(s), UV stabilizer(s), thermal stabilizer(s), pigment(s), other co-biocides, fibrous reinforcements, strength additives, compatibilizers, water repellants and/or fire retardants.

10. The coating of claim 1, wherein the effective amount of nanosized metal or metal oxide is in the range of approximately 0.05% -10.0% of the coating by dry weight.

11. The coating of claim 1, wherein said roofing products may be selected from the group consisting of: asphalt shingles; concrete tiles; thermoplastic and thermoset shakes, slates and tiles; wood shakes; metal shakes and panels; fiber cement shakes, slates and tiles, single ply membranes such as polyvinyl chloride (PVC), thermoplastic olefin (TPO), EPDM and neoprene rubber, hypalon, and similar membranes, polymer modified bitumen membranes, build-up roofing (BUR) systems, and roof accessories.

12. The coating of claim 1, wherein the nanosized metal or metal oxide in said coating is effective in killing and/or preventing the growth of mold, fungus, algae or bacteria on the roofing products.

13. A method of coating a roofing product with a nanosized particle-containing biocidal formulation, the method comprising the steps of:
(a) applying a coating of the biocidal on a roofing product;
(b) spreading the biocidal formulation on said roofing; and
(c) optionally repeating steps (a) and/or (b) to provide multiple coats of the formulation.

14. The method of claim 13, wherein said nanoparticle-containing biocidal formulation comprises nanosized metal or metal oxides.

15. The method of claim 13, wherein said nanosized metal or metal oxides include nanosized copper oxide or nanosized zinc oxide or combinations thereof.

16. The method of claim 13, wherein said coating may be applied by spraying, brushing, rolling or dipping during construction of said substrates in the plant

17. The method of claim 13, wherein said coating may be applied by spraying, brushing, rolling or dipping during or after roof installations.
